(19) United States
(12) Patent Application Publication
(10) Pub. No.: US 2009/0276229 A1
(43) Pub. Date: Nov. 5, 2009

(54) METHODS OF MONITORING THE EFFECT OF NUTRITIONAL PRODUCTS

(76) Inventors: Martin Grigorov, Epalinges (CH); Laurent-Bernard Fay, Evian (FR)

Correspondence Address: K&L Gates LLP, P.O. Box 1135, CHICAGO, IL, 60690, US

(21) Appl. No.: 12/112,844

(22) Filed: Apr. 30, 2008

(51) Int. Cl. G06Q 50/00

(52) U.S. Cl. 705/1

(57) ABSTRACT

Methods of measuring the effects of nutritional products on a consumer and generating revenue from products related to same are provided. In a general embodiment, the present disclosure provides a method of monitoring one or more effects of a nutritional product on a consumer. The method comprises providing a nutritional product and a personal monitoring device for use by a consumer and measuring an effect that the nutritional product has on the consumer using the personal monitoring device.

### BACKGROUND

The present disclosure is directed to health-related technologies. More specifically, the present disclosure is directed to methods of measuring the effects of nutritional products on a consumer and generating revenue from products related to same.

Medical monitoring devices for clinical purposes are numerous. Such well known devices include, for example, x-ray machines, ultra sound devices, computerized axial tomography scanners (CAT scanners) that produce a tomography that constructs a 3-D model of an object by combining parallel planes, electrocardiograms (ECG/EKG) monitoring systems for the electrical recording of the heart and use in the investigation of heart disease, electroencephalogram (EEG) systems for brain mapping and neuro-feedback, and Positron Emission Tomography (PET) scanning for brain imaging and related analysis. Nevertheless, these medical monitoring devices are bulky and require a patient being examined using the devices to go to a hospital or other medical center.

### SUMMARY

The present disclosure is directed to methods of measuring the effects of nutritional products on a consumer and generating revenue from products related to same. In a general embodiment, the present disclosure provides a method of monitoring one or more effects of a nutritional product on a consumer. The method comprises providing a nutritional product and a personal monitoring device for use by the consumer and measuring an effect that the nutritional product has on the consumer using the personal monitoring device.

In an embodiment, the nutritional product and the personal monitoring device are provided as part of a packaged assembly.

In an embodiment, the effect relates to a biological characteristic of the consumer.

In an embodiment, the effect of the nutritional product is measured in real time.

In an embodiment, the personal monitoring device is in communication with a central computer.

In an embodiment, the central computer is located at a health provider site.

In an embodiment, the central computer is located at a residence of the consumer.

In an embodiment, the central computer is located at a corporate site.

In an embodiment, the personal monitoring device is a portable device selected from the group consisting of a blood testing device, a bone density measuring device, a blood pressure monitoring device, a glucose monitoring device and combinations thereof.

In an embodiment, the nutritional product is selected from the group consisting of dairy drink, dairy powder, cereal bar, protein bar, vegetable drink and combinations thereof.

In an embodiment, the nutritional product comprises a component selected from the group consisting of bioactive ingredients, vitamins, minerals, proteins, sugars, fibers and combinations thereof.

In an embodiment, the consumer is a human or an animal.

In another embodiment, the present disclosure provides a method of monitoring an effect of a product on a consumer. The method comprises providing a nutritional product and a personal monitoring device to the consumer, wherein the consumer consumes the nutritional product, measuring an effect that the dietary nutritional product has on the consumer using the personal monitoring device, and collecting data from the personal monitoring device related to the effect on a computer.

In an embodiment, the personal monitoring device wirelessly communicates with the computer.

In an embodiment, the method further comprises organizing and displaying the data on the computer.

In an alternative embodiment, the present disclosure provides a method for generating revenue. The method comprises providing a nutritional product and a personal monitoring device, selling the nutritional product and the personal monitoring device to a consumer, and enabling the consumer to measure an effect of the nutritional product using the personal monitoring device at any location.

In an embodiment, the nutritional product is sold in a set of seven or more.

In yet another embodiment, the present disclosure provides a method for generating revenue. The method comprises selling a nutritional product to a consumer, providing a personal monitoring device to a consumer as a result of the consumer purchasing the nutritional product, and enabling the consumer to measure an effect of the nutritional product using the personal monitoring device at any location.

An advantage of the present disclosure is to provide an improved method of monitoring the effect of nutritional products on a consumer.

Another advantage of the present disclosure is to provide a method of measuring the effect of nutritional products on a consumer in real time.

Yet another advantage of the present disclosure is to provide a method of measuring the effect of nutritional products on a consumer at any location.

Still another advantage of the present disclosure is to provide an improved packaged assembly for measuring the effect of nutritional products.

Another advantage of the present disclosure is to provide a method of generating revenue by selling packaged assemblies that measure the effect of nutritional products on a consumer.

Additional features and advantages are described herein, and will be apparent from the following Detailed Description and the figures.

### BRIEF DESCRIPTION OF THE FIGURES

FIGS. 1A and 1B illustrate a milk powder product and personal monitoring device in an embodiment of the present disclosure.

FIGS. 2A and 2B illustrate a milk powder product and personal monitoring device in another embodiment of the present disclosure.

FIGS. 3A and 3B illustrate a vegetable drink product and personal monitoring device in an alternative embodiment of the present disclosure.

FIGS. 4A, 4B and 46 illustrate a cereal bar product and personal monitoring device in another embodiment of the present disclosure.

### DETAILED DESCRIPTION

The present disclosure is directed to methods of measuring the effects of nutritional products on a consumer and generating revenue from products related to same. In a general embodiment, one or more nutritional products are coupled with one or more personal monitoring devices for monitoring the effects that the nutritional products have on a consumer. The personal monitoring devices can be portable devices and used independently of specialized medical personnel. The methods and devices set forth herein can provide an economical and affordable way of measuring health benefits associated with nutritional products when compared to other conventional methods.

In an embodiment, the present disclosure provides a method of monitoring an effect of a nutritional product on a consumer. The consumer can be a human or an animal such as a pet. The method comprises providing one or more nutritional products and a personal monitoring device for use by the consumer and measuring an effect that the nutritional product has on the consumer using the personal monitoring device. The method can provide a way to objectively assess the advantages and benefits of the nutritional product(s) on the consumer by the use of the personal monitoring device, which can be enabled with wireless technology and connected to centralized or home-based computer systems.

In another embodiment, the method comprises providing to a consumer (e.g. human, pet owner) a personal monitoring device to follow and measure the effects of a healthy diet on his/her own or his/her pet's physiological status. As a result, the healthy diet can be ensured by consuming nutritional products enriched in healthy ingredients to address specific physiological needs. The nutritional products can comprise any suitable types of ingredients or components such as bioactive ingredients, vitamins, minerals, proteins, sugars, fibers, or a combination thereof. The nutritional products can be any suitable form such as, for example, a dairy drink, dairy powder, cereal bar, protein bar, vegetable drink, or a combination thereof.

The nutritional product and the personal monitoring device can be sold to the consumer individually or as part of a packaged assembly. The packaged assembly of the nutritional product and personal monitoring device can contain everything that the consumer will need to monitor one or more biological effects of the nutritional product at their house or any suitable location.

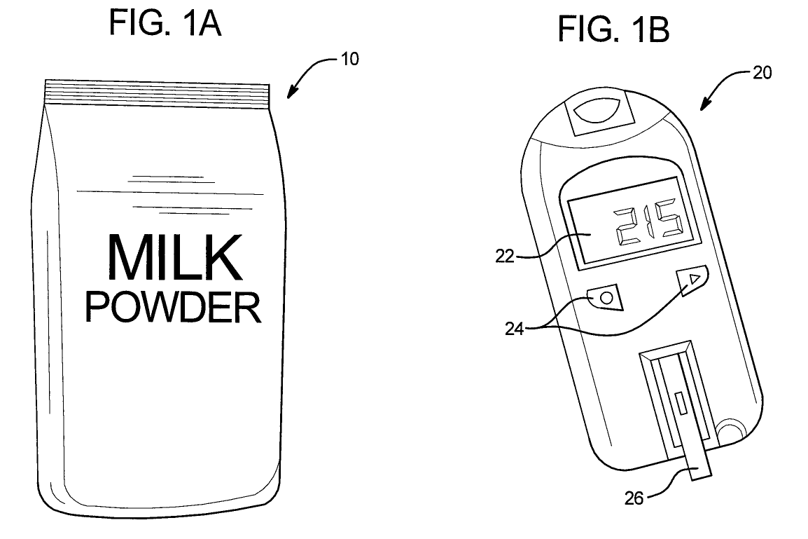

In an embodiment illustrated in FIGS. 1A and 1B, a milk powder product 10 and blood testing device 20 can be provided or sold to a consumer. The blood testing device 20 can be used, for example, to test for the effect that the milk powder product 10 has on the cholesterol of the consumer. The blood testing device 20 can comprise a screen 22 that displays information related to the effect(s) of the milk powder product 10 on the consumer. The blood testing device 20 can further comprise any suitable input keys 24 for operating the blood testing device 20. The blood testing device 20 can also be used in conjunction with various components such as a testing strip 26 that contains a biological sample from a consumer. The testing strip 26 can be placed inside the blood testing device 20 and evaluated.

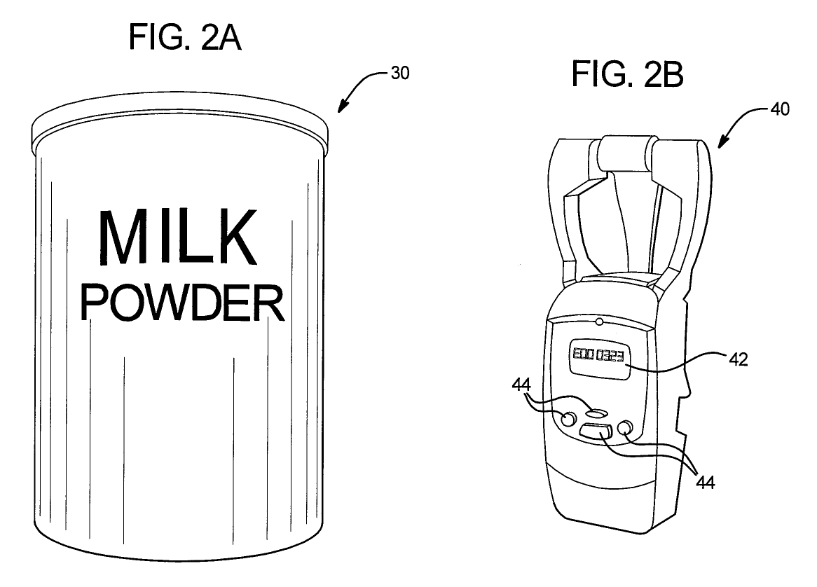

In another embodiment illustrated in FIGS. 2A and 2B, a milk powder product 30 and a bone density measuring device 40 can be provided or sold to a consumer. The bone density measuring device 40 can comprise a screen 42 that displays information related to the effect(s) of the milk powder product 30 on the consumer. The bone density measuring device 40 can further comprise any suitable input keys 44 for operating the bone density measuring device 40.

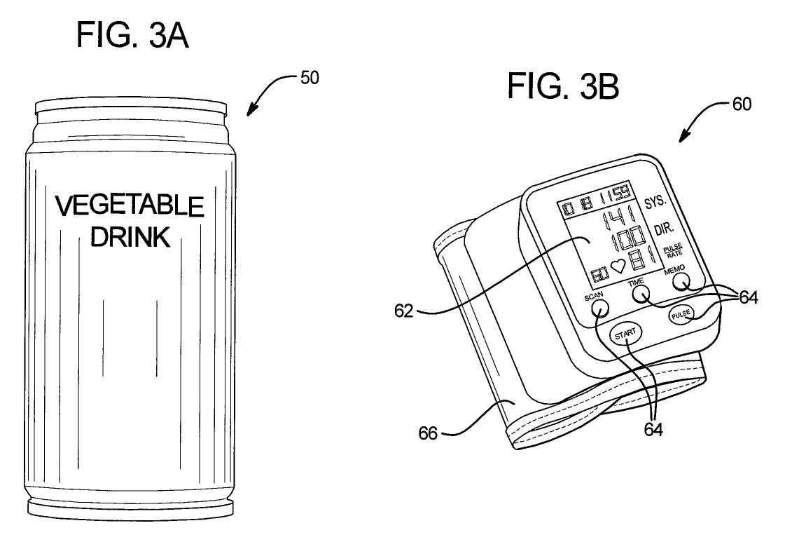

In an alternative embodiment illustrated in FIGS. 3A and 3B, a vegetable drink product 50 and a blood pressure monitoring device 60 can be provided or sold to a consumer. The blood pressure monitoring device 60 can comprise a screen 62 that displays information related to the effect(s) of the vegetable drink product 50 on the consumer. The blood pressure monitoring device 60 can further comprise any suitable input keys 64 for operating the blood pressure monitoring device 60. The blood pressure monitoring device 60 can comprise a strap 66 that allows a user to wear the blood pressure monitoring device 60.

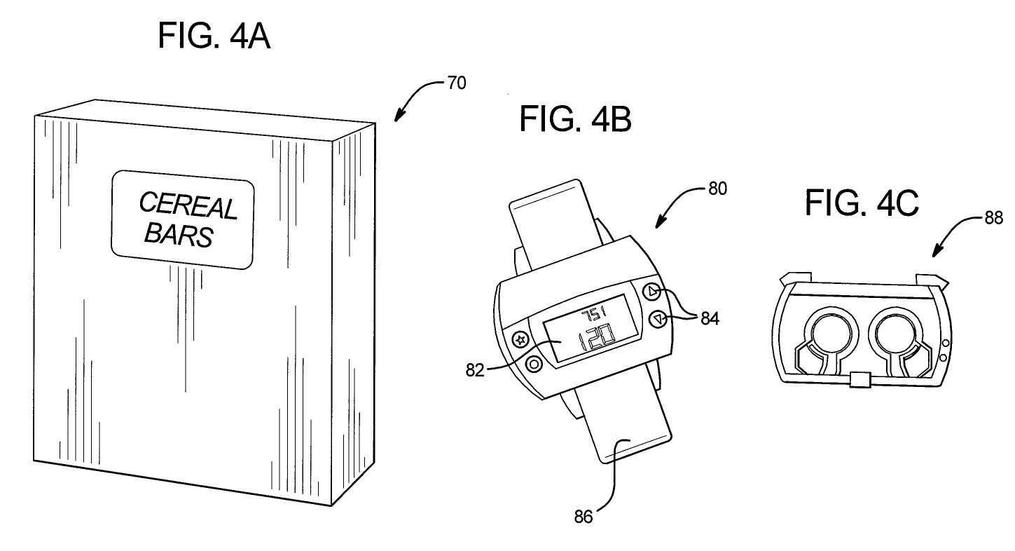

In yet another embodiment illustrated in FIGS. 4A, 4B and 4C, a cereal bar product 70 and a glucose monitoring device 80 can be provided or sold to a consumer. The glucose monitoring device 80 can comprise a screen 82 that displays information related to the effect(s) of the cereal bar product 70 on the consumer. The glucose monitoring device 80 can further comprise any suitable input keys 84 for operating the glucose monitoring device 80. The glucose monitoring device 80 can comprise a strap 86 that allows a user to wear the glucose monitoring device 80. The glucose monitoring device 80 can be used in conjunction with an autosensor pad 88 that can be attached to the glucose monitoring device 80. The autosensor pad 88 can stick to the skin of a consumer and measure glucose levels at the surface of the skin.

It should be appreciated that various nutritional products can be provided with any type of personal monitoring device in alternative embodiments of the present disclosure. The personal monitoring device can also be designed for determining health effects specifically related to the nutritional product and the benefits the nutritional product provides. The personal monitoring device can also comprise one or more features and capabilities of different monitoring devices as well.

The consumer can consumer the nutritional product at any time of the day. Data about the effects that the nutritional product is having on the consumer (e.g. human, animal) that is collected and processed by the personal monitoring devices can be acquired in real time. For example, data can be collected a discrete intervals of the day such as every 10 minutes or every hour.

In an embodiment, the data can also be transmitted by a wireless link to a central computer such as a personal/palm/home computer device without requiring the involvement or intervention from medical professionals. For example, the central computer can be located at a health provider site. The central computer can collect, organize, display and/or archive the data for use at any time by the consumer. For example, the consumer can consult the data history to make personal decisions about his or her healthy diet and to choose which nutritional products most benefit the health and well-being of the consumer.

In another embodiment, the central computer is located at a health provider site. As a result, a health care provider for the consumer can monitor over a predetermined amount of time the effect of a suggested dietary regimen of a patient to determine whether the dietary regimen is working or needs to be modified.

In an alternative embodiment, the central computer is located at a corporate site. For example, the corporation can collect data regarding the effect of the corporation's brand products on a range of individuals. This information can be used for strategic development of new products tailored to specific individuals' health needs.

In yet another embodiment, the present disclosure provides a method for generating revenue (e.g. for an organization or a corporation). The method comprises providing a nutritional product and a personal monitoring device. An organization, corporation or other entity can generate the revenue by selling the nutritional product and the personal monitoring device to a consumer, and enabling the consumer to measure an effect of the nutritional product using the personal monitoring device at any location.

The nutritional product and the personal monitoring device can be combined, marketed and sold in a single packaged assembly to the consumer to provide a comprehensive product that can address one or more of the consumer's specific physiological needs. Combining the nutritional product and the personal monitoring device to the consumer to track the effects of the nutritional product provides an incentive for the consumer to purchase the packaged assembly. The nutritional products can also be sold in sets (e.g. 7 or more) in the packaged assembly as a way of increasing the amount of revenue generated.

In yet another embodiment, the present disclosure provides a method for generating revenue. The method comprises selling a nutritional product to a consumer, providing a personal monitoring device to a consumer as a result of the consumer purchasing the nutritional product, and enabling the consumer to measure an effect of the nutritional product using the personal monitoring device at any location. The organization, corporation or other entity can generate the revenue by selling any suitable number of the nutritional products to the consumer. Giving the personal monitoring device to the consumer to track the effects of the nutritional product provides an incentive for the consumer to purchase the nutritional products. The nutritional products can also be sold in sets (e.g. 7 or more) as a way of increasing the amount of revenue generated.

### EXAMPLES

By way of example and not limitation, the following examples are illustrative of various embodiments of the present disclosure.

### Example 1

An example of a healthy product designed to address a specific physiological needs is the shelf-stable NESVITA™ milk powder product enriched with phytosterols (BAB Acticol) to prevent the increase of bad cholesterol. The milk powder product can be provided to a consumer. The milk powder product can be marketed and sold in a box of 7 sachets (e.g. for weekly use) combined with a device such as the CARDIOCHEK® set of strips and electronic hand-held device that will allow the consumer to measure the effect of consuming the NESVITA™ milk drink on a daily basis, directly and independently of specialized medical personnel. The CARDIOCHEK® PA strips/electronic hand-held device is approved by the FDA.

### Example 2

A shelf-stable NESVITA® milk powder product enriched with casein-derived peptides to restore slightly elevated blood pressure to its normal levels can be provided in beverage form to a consumer. The milk powder product can be marketed and sold in a box of 7 sachets (for weekly use) combined with a device such as the Bluetooth Blood Pressure Monitor marketed by Mytech Technology Co. Ltd. that is approved by the FDA. Such a device will allow to the consumer to follow in real-time the evolution of his/her blood pressure while consuming the NESVITA® milk drink on a daily basis.

### Example 3

A shelf-stable SVELTY® milk powder product, enriched in vitamins and calcium to provide a supplement of calcium for women at risk of osteoporosis can be provided to a consumer. The milk powder product can be marketed and sold in a box of 7 sachets combined with a device such as the Osteomark® NTx that has been approved by the FDA for monitoring the bone density of patients at risk.

### Example 4

A NUTREN BALANCE® cereal bar that is a specially formulated snack choice is provided to a consumer. The cereal bars have a balanced nutritional composition and contain BG-3, a natural fiber from oats. BG-3 (beta-glucan), in the context of a balanced diet, helps to control blood glucose by slowing glucose absorption. The cereal bars can be marketed and sold in a box of bars combined with a monitoring device such as the GLUCOWATCH® G2 Biographer glucose monitoring system that is intended for detecting trends and tracking patterns in glucose levels in adults.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method of monitoring an effect of a product on a consumer, the method comprising:
providing a nutritional product and a personal monitoring device as packaged assembly for use by the consumer; and
measuring an effect that the nutritional product has on the consumer using the personal monitoring device.

2. The method of claim 1, wherein the nutritional product and the personal monitoring device are provided as part of a packaged assembly.

3. The method of claim 1, wherein the effect relates to a biological characteristic of the consumer.

4. The method of claim 1, wherein the effect of the nutritional product is measured in real time.

5. The method of claim 1, wherein the personal monitoring device is in communication with a central computer.

6. The method of claim 5, wherein the central computer is located at a health provider site.

7. The method of claim 5, wherein the central computer is located at a residence of the consumer.

8. The method of claim 5, wherein the central computer is located at a corporate site.

9. The method of claim 1, wherein the personal monitoring device is a portable device selected from the group consisting of a blood testing device, a bone density measuring device, a blood pressure monitoring device, a glucose monitoring device and combinations thereof.

10. The method of claim 1, wherein the nutritional product is selected from the group consisting of dairy drink, dairy powder, cereal bar, protein bar, vegetable drink and combinations thereof.

11. The method of claim 1, wherein the nutritional product comprises a component selected from the group consisting of bioactive ingredients, vitamins, minerals, proteins, sugars, fibers and combinations thereof.

12. The method of claim 1, wherein the consumer is selected from the group consisting of a human and an animal.

13. A method of monitoring an effect of a product on a consumer, the method comprising:
providing a nutritional product and a personal monitoring device to the consumer, wherein the consumer consumes the nutritional product;
measuring an effect that the dietary nutritional product has on the consumer using the personal monitoring device; and
collecting data from the personal monitoring device related to the effect on a computer.

14. The method of claim 13, wherein the nutritional product and the personal monitoring device are provided as part of a packaged assembly.

15. The method of claim 13, wherein the personal monitoring device wirelessly communicates with the computer.

16. The method of claim 13 further comprising organizing and displaying the data on the computer.

17. The method of claim 13, wherein the personal monitoring device is a portable device selected from the group consisting of a blood testing device, a bone density measuring device, a blood pressure monitoring device, a glucose monitoring device and combinations thereof.

18. A method for generating revenue, the method comprising:
providing a nutritional product and a personal monitoring device;
selling the nutritional product and the personal monitoring device to a consumer; and
enabling the consumer to measure an effect of the nutritional product using the personal monitoring device at any location.

19. The method of claim 18, wherein the nutritional product and the personal monitoring device are sold as part of a packaged assembly.

20. The method of claim 18, wherein the nutritional product is sold in a set of at least seven.

21. The method of claim 18, wherein the effect of the nutritional product is measured in real time.

22. The method of claim 18, wherein the personal monitoring device is a portable device selected from the group consisting of a blood testing device, a bone density measuring device, a blood pressure monitoring device, a glucose monitoring device and combinations thereof.

23. A method for generating revenue, the method comprising:
selling a nutritional product to a consumer;
providing a personal monitoring device to a consumer as a result of the consumer purchasing the nutritional product; and
enabling the consumer to measure an effect of the nutritional product using the personal monitoring device at any location.

24. The method of claim 23, wherein the nutritional product is sold in a set of at least seven.
